(19) United States
(12) Patent Application Publication
(10) Pub. No.: US 2026/0081518 A1
(43) Pub. Date: Mar. 19, 2026

(54) POWER SUPPLY APPARATUS, METHOD FOR POWER SUPPLY APPARATUS, AND REDUNDANT POWER SUPPLY SYSTEM

(71) Applicant: Murata Manufacturing Co., Ltd., Nagaokakyo-shi (JP)

(72) Inventors: Chukhung CHAN, Hong Kong (CN); Chuipong LIU, Hong Kong (CN)

(21) Appl. No.: 19/320,251

(22) Filed: Sep. 5, 2025

(30) Foreign Application Priority Data
Sep. 14, 2024 (CN) 202411295493.6

(51) Int. Cl. H02M 1/32; H02J 9/06; H02M 1/00; H02M 1/36

(52) U.S. Cl. CPC H02M 1/32; H02J 9/06; H02M 1/0009; H02M 1/36

(57) ABSTRACT

A power supply apparatus includes a power converter, a controller, an ORing device, and a first feedback module. The power converter is configured to provide an output voltage via the ORing device. The first feedback module is connected between a downstream node of the ORing device and the controller and is configured to provide a first voltage feedback to the controller. The power supply apparatus further includes a second feedback module connected between an upstream node of the ORing device and the controller and configured to provide a second voltage feedback to the controller, and a third feedback module connected between the upstream node of the ORing device and the controller and configured to provide a third voltage feedback to the controller. The controller is configured or programmed to control the power supply apparatus based on the first voltage feedback, the second voltage feedback, and the third voltage feedback.

### CROSS REFERENCE TO RELATED APPLICATIONS

This application claims the benefit of priority to Chinese Patent Application No. 202411295493.6, filed on Sep. 14, 2024. The entire contents of this application are hereby incorporated herein by reference.

### BACKGROUND OF THE INVENTION

### 1. Field of the Invention

The present disclosure relates to power supply apparatuses, methods for power supply apparatuses, and redundant power supply systems. More specifically, the present disclosure relates to power supply apparatuses including a plurality of voltage feedbacks, methods for the power supply apparatuses, and redundant power supply systems.

### 2. Description of the Related Art

A redundant power supply system may have a plurality of power supply units, and outputs of the plurality of power supply units are connected to each other through an output common bus. These power supply units may operate separately and share a system load.

### SUMMARY OF THE INVENTION

In an example embodiment of the present disclosure, a power supply apparatus includes a power converter, a controller, an ORing device, and a first feedback module. The power converter is configured to provide an output voltage via the ORing device, and the first feedback module is connected between a downstream node of the ORing device and the controller and is configured to provide a first voltage feedback to the controller. The power supply apparatus further includes a second feedback module connected between an upstream node of the ORing device and the controller and configured to provide a second voltage feedback to the controller and further includes a third feedback module connected between the upstream node of the ORing device and the controller and configured to provide a third voltage feedback to the controller, where the controller is configured or programmed to control the power supply apparatus based on the first voltage feedback, the second voltage feedback, and the third voltage feedback.

According to an example embodiment of the present disclosure, the controller is further configured or programmed to detect a state of the power supply apparatus, and the state of the power supply apparatus includes at least one of a component fault state, an over-voltage state, or an under-voltage state.

According to an example embodiment of the present disclosure, each of the first feedback module, the second feedback module, and the third feedback module includes a feedback line and a resistor network, the feedback line is connected between the controller and a node between resistors in the resistor network, and each of the first voltage feedback, the second voltage feedback, and the third voltage feedback is transmitted to the controller through a corresponding feedback line.

According to an example embodiment of the present disclosure, the controller is further configured or programmed to obtain a first reflected voltage, a second reflected voltage, and a third reflected voltage, respectively, based on the first voltage feedback, the second voltage feedback, and the third voltage feedback; the first reflected voltage is a voltage at the downstream node of the ORing device reflected by the first voltage feedback, the second reflected voltage is a voltage at the upstream node of the ORing device reflected by the second voltage feedback, and the third reflected voltage is a voltage at the upstream node of the ORing device reflected by the third voltage feedback; and when the power supply apparatus is in a normal operating state, the first reflected voltage is equal or substantially equal to a first normal regulation voltage, and the second reflected voltage and the third reflected voltage are equal or substantially equal to a second normal regulation voltage greater than or equal to the first normal regulation voltage.

According to an example embodiment of the present disclosure, the controller is further configured or programmed to regulate the output voltage of the power converter based on the first reflected voltage when the first reflected voltage is less than or equal to the second reflected voltage; the controller is further configured or programmed to regulate the output voltage of the power converter based on the second reflected voltage when the first reflected voltage is greater than the second reflected voltage; and the controller is further configured or programmed to detect an over-voltage OV or an under-voltage UV based on the third reflected voltage.

According to an example embodiment of the present disclosure, the controller is further configured or programmed to detect a component fault state and report a component fault when any one of the following conditions is met: the first reflected voltage is greater than the first normal regulation voltage, the second reflected voltage and the third reflected voltage are identical or substantially identical to each other and equal or substantially equal to the second normal regulation voltage, and an output current of the power converter is greater than a fault current threshold; the first reflected voltage is equal or substantially equal to the first normal regulation voltage, the second reflected voltage is greater than the second normal regulation voltage, and the third reflected voltage is equal or substantially equal to the second normal regulation voltage; the second reflected voltage is equal or substantially equal to the second normal regulation voltage, and the third reflected voltage is less than the second normal regulation voltage; or the first reflected voltage is equal or substantially equal to the first normal regulation voltage, the second reflected voltage is equal or substantially equal to the second normal regulation voltage, and the third reflected voltage is greater than the second normal regulation voltage.

According to an example embodiment of the present disclosure, the UV detected based on the third reflected voltage is determined as a faulty UV when the second reflected voltage is equal or substantially equal to the second normal regulation voltage.

According to an example embodiment of the present disclosure, the OV detected based on the third reflected voltage is determined as a faulty OV when the first reflected voltage is equal or substantially equal to the first normal regulation voltage as well as the second reflected voltage is equal or substantially equal to the second normal regulation voltage.

According to an example embodiment of the present disclosure, the controller is further configured or programmed to turn off an output of the power converter when reporting the component fault.

According to an example embodiment of the present disclosure, the controller is further configured or programmed to detect an OV state and a component fault state and to turn off an output of the power converter when any one of the following conditions is met: the first reflected voltage is less than or equal to the first normal regulation voltage, and the second reflected voltage and the third reflected voltage are identical or substantially identical to each other and greater than the second normal regulation voltage; or the first reflected voltage is greater than the first normal regulation voltage, the second reflected voltage is less than or equal to the second normal regulation voltage, and the third reflected voltage is greater than the second normal regulation voltage.

According to an example embodiment of the present disclosure, the controller is further configured or programmed to detect an OV state, report the OV, and turn off an output of the power converter when the following condition is met: the first reflected voltage is greater than the first normal regulation voltage, and the second reflected voltage and the third reflected voltage are identical or substantially identical to each other and greater than the second normal regulation voltage.

According to an example embodiment of the present disclosure, the controller is further configured or programmed to detect a UV state, report the UV, and turn off an output of the power converter when the following condition is met: the second reflected voltage and the third reflected voltage are identical or substantially identical to each other and less than the second normal regulation voltage.

In another example embodiment of the present disclosure, a method for a power supply apparatus is provided, where the power supply apparatus includes a power converter, a controller, and an ORing device, and the power converter is configured to provide an output voltage via the ORing device. The method includes providing a first voltage feedback, a second voltage feedback, and a third voltage feedback to the controller respectively by a first feedback module, a second feedback module, and a third feedback module of the power supply apparatus; and controlling the power supply apparatus by the controller based on the first voltage feedback, the second voltage feedback, and the third voltage feedback, where the first feedback module is connected between a downstream node of the ORing device and the controller, the second feedback module is connected between an upstream node of the ORing device and the controller, and the third feedback module is connected between the upstream node of the ORing device and the controller.

In another example embodiment of the present disclosure, a redundant power supply system is provided, including a plurality of power supply apparatuses and an output common bus, where each of the plurality of power supply apparatuses is the power supply apparatus as described above, and outputs of the plurality of power supply apparatuses are connected to the output common bus.

The above and other elements, features, steps, characteristics and advantages of the present invention will become more apparent from the following detailed description of the example embodiments with reference to the attached drawings.

### BRIEF DESCRIPTION OF THE DRAWINGS

Other elements, features and advantages of the present disclosure will become more clear from the following detailed description of example embodiments with reference to the accompanying drawings.

FIG. 1 shows a schematic diagram of a redundant power supply system of the related art.

FIG. 2 shows a schematic diagram of a redundant power supply system according to an example embodiment of the present invention.

FIG. 3 shows a schematic diagram of a controller obtaining a VFB1-reflected voltage based on a voltage feedback VFB1.

FIG. 4 shows a schematic block diagram of a power supply apparatus according to an example embodiment of the present invention.

FIG. 5 shows a method for a power supply apparatus according to an example embodiment of the present invention.

### DETAILED DESCRIPTION OF THE EXAMPLE EMBODIMENTS

Hereinafter, example embodiments of the present disclosure will be described with reference to the accompanying drawings. However, it should be understood that these descriptions are only exemplary and are not intended to limit the scope of the present disclosure. In addition, the in following description, descriptions of well-known structures and technologies are omitted to avoid unnecessarily obscuring the concept of the present disclosure.

The terms used herein are only for describing specific example embodiments and are not intended to limit the present disclosure. The words “a”, “an”, and “the” used herein should also include the plural forms unless the context clearly indicates otherwise. In addition, the terms “including”, “containing”, “comprising”, and the like used herein indicate the presence of the described features, steps, operations, and/or components, but do not exclude the presence or addition of one or more other features, steps, operations, or components.

All terms (including technical and scientific terms) used herein have the meanings commonly understood by those skilled in the art, unless otherwise defined. It should be noted that the terms used herein should be interpreted as having meanings consistent with the context of this specification and should not be interpreted in an idealized or overly rigid manner.

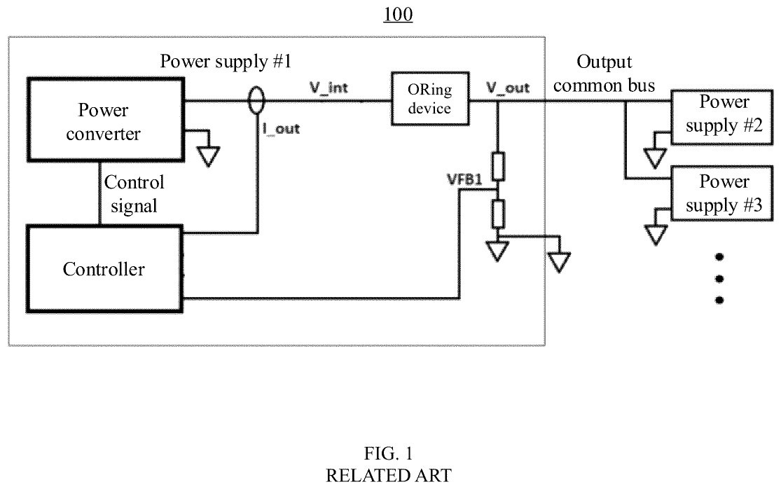

When any power supply or load in the system is abnormal, for example, when any load or power supply experiences a fault such as a short circuit or overload, the entire power bus may be affected directly, causing all devices on the output common bus to be affected and fail to operate normally. For example, in a redundant power supply system 100 shown in FIG. 1, if the output of power supply #2 experiences a short circuit, the output of power supply #1 may also be short-circuited and power supply #1 may fail to supply power to the system because power supply #1, power supply #2, and power supply #3 are physically connected directly through the output common bus.

To prevent an output fault of one power supply from affecting the whole system operation, a power supply output may be provided with an ORing device (e.g., a rectifier or a MOSFET), which may isolate a faulty power supply from the output common bus. Here, the ORing device may be referred to as a unidirectional conductive circuit, which functions to ensure that each power supply operates separately without reverse current flow. As the ORing device only allows current to flow in a single direction, it may provide fault isolation for the redundant bus. Whenever a power supply output voltage V_out is higher than an input voltage V_int of the ORing device (i.e., an output voltage of a power converter), the ORing device should be turned off.

Each power supply in the redundant power supply system should have a controller that regulates the power supply output voltage V_out through a control signal. A voltage feedback (see VFB1 in FIG. 1) for output regulation is preferably connected to a node downstream of the ORing device through a resistor network, so that a voltage on the output common bus may be regulated properly. When the output voltage of one power supply is regulated above that of other power supplies, other power supplies may receive a high voltage feedback, and their controllers may reduce the output of their respective power converters. As a result, the voltage V_int upstream of the ORing device may drop to be a very low voltage, and the ORing device is turned off. In this case, if the power supply with the highest output voltage is turned off suddenly, the voltage on the output common bus will drop rapidly and affect the system operation. Therefore, it is necessary to provide an additional voltage feedback upstream of the ORing device to monitor the voltage V_int.

Example embodiments of the present disclosure provide a solution for designing a power supply output feedback signal of a redundant power supply system, so as to reliably maintain a voltage on a common bus, while enabling a controller to correctly report over-voltage and under-voltage states as well as component fault states.

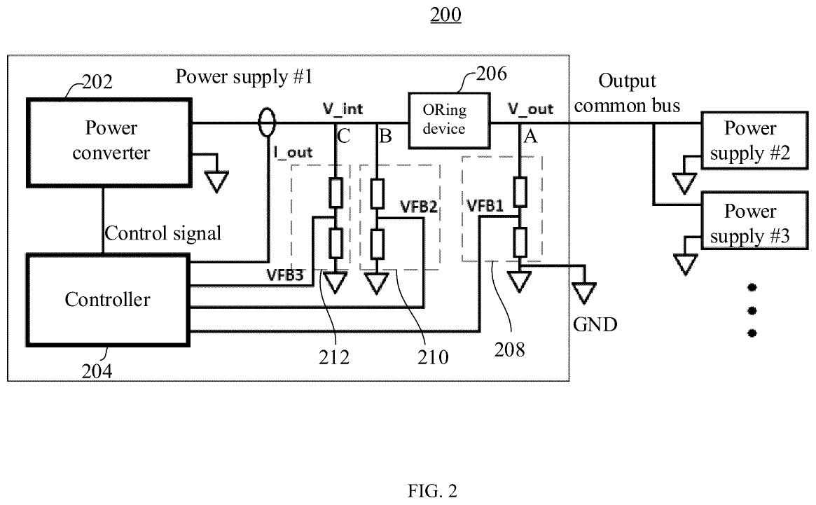

FIG. 2 shows a schematic diagram of a redundant power supply system 200 according to an example embodiment.

In the accompanying drawings, components with the same reference numerals may be considered as the same or similar components. Hereinafter, repeated descriptions of similar components will be omitted, and differences from the redundant power supply system 100 shown in FIG. 1 will be mainly described. FIG. 2 shows that the redundant power supply system 200 may include power supply #1, power supply #2, and power supply #3, but the present disclosure is not limited thereto, and the redundant power supply system 200 may include any number of power supplies.

Referring to FIG. 2, in addition to a voltage feedback (VFB1) for output regulation (for example, a first feedback module 208), a second feedback module 210 is further provided, which is used to provide another voltage feedback (VFB2) for output regulation to a controller 204. As shown in FIG. 2, the second feedback module 210 may be connected between a point upstream of an ORing device 206 (for example, upstream node B) and the controller 204, and also connected to ground. Under normal operating conditions, the controller 204 may use VFB1 rather than VFB2 for output feedback control to properly regulate the voltage on the output common bus. A voltage reflected by VFB2 may be higher than or equal to a voltage reflected by VFB1, which is due to a voltage drop across the ORing device 206 when an output current I_out is non-zero. Here, the voltage reflected by VFB1 may be a voltage at a downstream node A obtained by the controller 204 based on VFB1, and may be referred to as a VFB1-reflected voltage or first reflected voltage. Similarly, the voltage reflected by VFB2 may be a voltage at the upstream node B obtained by the controller 204 based on VFB2, and may be referred to as a VFB2-reflected voltage or second reflected voltage.

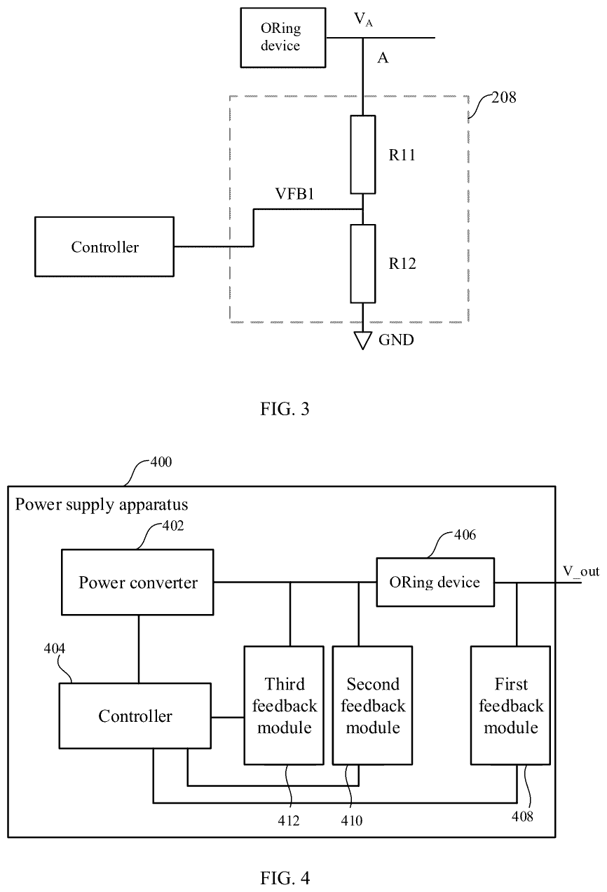

A process of the controller obtaining the VFB1-reflected voltage based on the voltage feedback VFB1 will be described below with reference to FIG. 3. FIG. 3 shows a schematic diagram of the controller obtaining the VFB1-reflected voltage based on the voltage feedback VFB1. In FIG. 3, the first feedback module 208 may include a resistor network and a feedback line. According to an example embodiment, the resistor network may be connected between a node downstream of the ORing device (for example, the downstream node A) and ground GND, and it may include a resistor R11 and a resistor R12, but the present disclosure is not limited thereto. The feedback line may be connected between the controller and a node between the resistor R11 and the resistor R12. The voltage feedback VFB1 may be transmitted to the controller through the feedback line. According to an example embodiment, after receiving the voltage feedback VFB1, the controller may obtain a voltage V_{A} at the downstream node A (i.e., the VFB1-reflected voltage) using the following equation:

$${V}_{A} = \frac{{R}_{11} + {R}_{12}}{{R}_{12}} * {V}_{VFB 1}$$

where R₁₁ and R₁₂ represent resistances of the resistor R11 and the resistor R12, respectively, and V_{VFB1} represents a voltage at the node between the resistor R11 and the resistor R12 (i.e., the voltage feedback VFB1). The above description also applies to the second feedback module 210 and a third feedback module 212 (to be described later), as well as to the VFB2-reflected voltage and a VFB3-reflected voltage (to be described later).

With reference to FIG. 2, the feedback voltage VFB2 may be used in the following cases.
1. When a power supply output is soft starting, the feedback voltage VFB2 may be used as feedback for output regulation. In a redundant power supply system, one or more power supplies (for example, power supply #2 or power supply #3) may start up early and have already provided the regulated voltage on the common bus. A newly starting power supply (for example, power supply #1) may turn off its ORing device to avoid affecting the voltage on the common bus. Using the feedback voltage VFB2 as feedback for output regulation may allow this power supply #1 to start its output slowly without affecting the common bus voltage.
2. In normal operation, if the VFB2-reflected voltage is lower than the VFB1-reflected voltage, the power supply controller may use the feedback voltage VFB2 for output regulation. As described above, the VFB2-reflected voltage being lower than the VFB1-reflected voltage may be due to the controller using the feedback voltage VFB1 for output regulation in response to other power supplies having higher regulated output, resulting in a drop in the internal voltage V_int (i.e., the output voltage of the power converter 202). In contrast, using the feedback voltage VFB2 for output regulation may keep the internal voltage V_int at its own regulation point. If other high-output power supplies are turned off, the output common bus will not have a sudden voltage drop.

Generally, the feedback voltage VFB2 may also be used for output monitoring. If the output V_int is under voltage or over voltage, the power supply should be turned off immediately. However, if a feedback resistor associated with the feedback voltage VFB2 (for example, a resistor in the second feedback module 210) has a problem such that the voltage reflected by the voltage feedback VFB2 (for example, the VFB2-reflected voltage) is lower than the real V_int, the controller 204 will use the feedback voltage VFB2 for output regulation (as described earlier in case 2) and increase the output voltage. Then, the common bus output will rise above the regulation point, and the output rise is not prevented.

As shown in FIG. 2, a third feedback module 212 is further provided, which is used to provide another voltage feedback (VFB3) for output regulation monitoring to the controller 204. According to an example embodiment, the third feedback module 212 may be connected between a point upstream of the ORing device (for example, upstream node C) and the controller 204, and also connected to ground. As described above, the voltage reflected by the feedback voltage VFB3 may be a voltage at the upstream node C obtained by the controller 204 based on the feedback voltage VFB3, and may be referred to as a VFB3-reflected voltage or third reflected voltage. Here, the upstream node C and the upstream node B may be considered as the same node, but the present disclosure is not limited thereto. According to an example embodiment, VFB3 may be an independent voltage monitoring signal for over-voltage protection or under-voltage protection. Therefore, as described above, if the voltage reflected by the voltage feedback VFB2 is lower than the real V_int due to the problem with the feedback resistor associated with VFB2, the controller 204 will use the feedback voltage VFB2 for output regulation and increase the output voltage, and then the common bus output will rise above the regulation point. In this case, over-voltage OV may be detected by the controller based on the feedback voltage VFB3. The power supply apparatus including the above three feedback modules according to an example embodiment will be described in detail below with reference to FIG. 4.

FIG. 4 shows a schematic block diagram of a power supply apparatus 400 according to an example embodiment.

Referring to FIG. 4, the power supply apparatus 400 may include a power converter 402, a controller 404, an ORing device 406, a first feedback module 408, a second feedback module 410, and a third feedback module 412. The controller 404 may be used to regulate an output voltage of the power converter 402. The power converter 402 may be used to provide an output voltage V_out via the ORing device 406. In an example embodiment, the first feedback module 408 may be connected between a downstream node of the ORing device and the controller 404 and may be used to provide a first voltage feedback to the controller 404, the second feedback module 410 may be connected between an upstream node of the ORing device 406 and the controller 404 and may be used to provide a second voltage feedback to the controller 404, and the third feedback module 412 may be connected between the upstream node of the ORing device 406 and the controller 404 and may be used to provide a third voltage feedback to the controller 404. In an example embodiment, the controller 404 may be used to control the power supply apparatus 400 based on the first voltage feedback, the second voltage feedback, and the third voltage feedback. In an example embodiment, controlling the power supply apparatus 400 may include detecting a state of the power supply apparatus 400. For example, the state of the power supply apparatus may include any one of a component fault state, an over-voltage OV state, or an under-voltage UV state.

According to an example embodiment, each of the first feedback module 408, the second feedback module 410, and the third feedback module 412 may include a feedback line and a resistor network. The feedback line may be connected between the controller and a node between resistors in the resistor network. In addition, each of the first voltage feedback, the second voltage feedback, and the third voltage feedback may be transmitted to the controller 404 through a corresponding feedback line.

According to an example embodiment, the controller 404 may be further used to obtain a first reflected voltage, a second reflected voltage, and a third reflected voltage, respectively, based on the first voltage feedback, the second voltage feedback, and the third voltage feedback, as described with reference to FIG. 3. The first reflected voltage may be a voltage at the downstream node reflected by the first voltage feedback, the second reflected voltage may be a voltage at the upstream node reflected by the second voltage feedback, and the third reflected voltage may be a voltage at the upstream node reflected by the third voltage feedback. Generally, when the power supply apparatus 400 is in a normal operating state, the first reflected voltage may be equal or substantially equal to a first normal regulation voltage, within manufacturing and/or measurement tolerances, and the second reflected voltage and the third reflected voltage may be equal to a second normal regulation voltage, within manufacturing and/or measurement tolerances. In addition, due to the voltage drop across the ORing device when current flows through the ORing device, the second normal regulation voltage may be greater than or equal to the first normal regulation voltage.

According to an example embodiment, when the first reflected voltage is less than or equal to the second reflected voltage, the controller 404 may regulate the output voltage of the power converter 402 based on the first reflected voltage; when the first reflected voltage is greater than the second reflected voltage, the controller 404 may regulate the output voltage of the power converter 402 based on the second reflected voltage; and the controller 404 may detect OV or UV based on the third reflected voltage.

According to an example embodiment, controlling the power supply apparatus 400 may include detecting a component fault state and reporting a component fault when one of the following conditions is met: the first reflected voltage is greater than the first normal regulation voltage, the second reflected voltage and the third reflected voltage are identical or substantially identical to each other, within manufacturing and/or measurement tolerances, and equal or substantially equal to the second normal regulation voltage, within manufacturing and/or measurement tolerances, and the output current of the power converter 402 is greater than a fault current threshold (to be described later); the first reflected voltage is equal or substantially equal to the first normal regulation voltage, within manufacturing and/or measurement tolerances, the second reflected voltage is greater than the second normal regulation voltage, and the third reflected voltage is equal or substantially equal to the second normal regulation voltage, within manufacturing and/or measurement tolerances; the second reflected voltage is equal or substantially equal to the second normal regulation voltage, within manufacturing and/or measurement tolerances, and the third reflected voltage is less than the second normal regulation voltage; or the first reflected voltage is equal or substantially equal to the first normal regulation voltage, within manufacturing and/or measurement tolerances, the second reflected voltage is equal or substantially equal to the second normal regulation voltage, within manufacturing and/or measurement tolerances, and the third reflected voltage is greater than the second normal regulation voltage.

According to an example embodiment, when the second reflected voltage is equal or substantially equal to the second normal regulation voltage, within manufacturing and/or measurement tolerances, the UV detected based on the third reflected voltage may be a faulty UV.

According to an example embodiment, when the first reflected voltage is equal or substantially equal to the first normal regulation voltage, within manufacturing and/or measurement tolerances, and the second reflected voltage is equal or substantially equal to the second normal regulation voltage, within manufacturing and/or measurement tolerances, the OV detected based on the third reflected voltage may be a faulty OV.

Moreover, in the case where the controller reports a component fault as described above, the controller may also turn off the output according to system requirements. Some systems may require the faulty power supply to remain on until it is replaced by maintenance personnel. However, some systems with sufficient redundant power supplies may require the faulty power supply to immediately turn off on its own. In this case, the controller 404 may be used to turn off the output of the power converter 402 while reporting the component fault.

According to an example embodiment, controlling the power supply apparatus 400 may further include detecting an OV state and a component fault state and turning off the output of the power converter 402 when one of the following conditions is met: the first reflected voltage is less than or equal to the first normal regulation voltage, and the second reflected voltage and the third reflected voltage are identical or substantially identical to each other, within manufacturing and/or measurement tolerances, and greater than the second normal regulation voltage; or the first reflected voltage is greater than the first normal regulation voltage, the second reflected voltage is less than or equal to the second normal regulation voltage, and the third reflected voltage is greater than the second normal regulation voltage.

According to an example embodiment, controlling the power supply apparatus 400 may further include detecting an OV state, reporting an OV, and turning off the output of the power converter 402 when the following condition is met: the first reflected voltage is greater than the first normal regulation voltage, and the second reflected voltage and the third reflected voltage are identical or substantially identical to each other, within manufacturing and/or measurement tolerances, and greater than the second normal regulation voltage.

According to an example embodiment, controlling the power supply apparatus 400 may further include detecting a UV state, reporting a UV, and turning off the output of the power converter 402 when the following condition is met: the second reflected voltage and the third reflected voltage are identical or substantially identical to each other, within manufacturing and/or measurement tolerances, and less than the second normal regulation voltage.

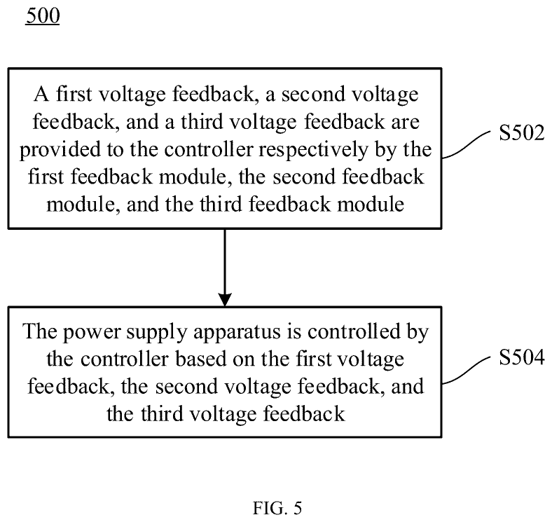

The detailed configuration of the power supply apparatus 400 according to an example embodiment has been described above with reference to FIG. 4. The power supply apparatus 400 may be applied to any power supply in the redundant power supply system 200 in FIG. 2. A method for the power supply apparatus 400 will be described below with reference to FIG. 5.

FIG. 5 shows a method 500 for a power supply apparatus according to an example embodiment. In an example embodiment, the power supply apparatus may be the power supply apparatus 400 described with reference to FIG. 4. Accordingly, as described above, the power supply apparatus may include a power converter, a controller, an ORing device, a first feedback module, a second feedback module, and a third feedback module. For simplicity, detailed descriptions of the power converter, controller, ORing device, first feedback module, second feedback module, and third feedback module will be omitted here.

The method 500 includes steps S502 and S504. In step S502, a first voltage feedback, a second voltage feedback, and a third voltage feedback are provided to the controller respectively by the first feedback module, the second feedback module, and the third feedback module.

Here, each of the first voltage feedback, the second voltage feedback, and the third voltage feedback may be transmitted to the controller through a corresponding feedback line as described above.

In step S504, the power supply apparatus may be controlled by the controller based on the first voltage feedback, the second voltage feedback, and the third voltage feedback.

According to an example embodiment, the method 500 may further include obtaining a first reflected voltage, a second reflected voltage, and a third reflected voltage by the controller respectively based on the first voltage feedback, the second voltage feedback, and the third voltage feedback. Details of the first reflected voltage, the second reflected voltage, and the third reflected voltage have been described above and will not be repeated here.

According to an example embodiment, controlling the power supply apparatus in step S504 may include detecting a component fault state and reporting a component fault when one of the following conditions is met: the first reflected voltage is greater than the first normal regulation voltage, the second reflected voltage and the third reflected voltage are identical or substantially identical to each other, within manufacturing and/or measurement tolerances, and equal or substantially equal to the second normal regulation voltage, within manufacturing and/or measurement tolerances, and the output current of the power converter 402 is greater than a fault current threshold; the first reflected voltage is equal or substantially equal to the first normal regulation voltage, within manufacturing and/or measurement tolerances, the second reflected voltage is greater than the second normal regulation voltage, and the third reflected voltage is equal or substantially equal to the second normal regulation voltage, within manufacturing and/or measurement tolerances; the second reflected voltage is equal or substantially equal to the second normal regulation voltage, within manufacturing and/or measurement tolerances, and the third reflected voltage is less than the second normal regulation voltage; or the first reflected voltage is equal or substantially equal to the first normal regulation voltage, within manufacturing and/or measurement tolerances, the second reflected voltage is equal or substantially equal to the second normal regulation voltage, within manufacturing and/or measurement tolerances, and the third reflected voltage is greater than the second normal regulation voltage.

According to an example embodiment, when the second reflected voltage is equal or substantially equal to the second normal regulation voltage, within manufacturing and/or measurement tolerances, the UV detected based on the third reflected voltage may be a faulty UV.

According to an example embodiment, when the first reflected voltage is equal or substantially equal to the first normal regulation voltage, within manufacturing and/or measurement tolerances, and the second reflected voltage is equal or substantially equal to the second normal regulation voltage, within manufacturing and/or measurement tolerances, the OV detected based on the third reflected voltage may be a faulty OV.

According to an example embodiment, controlling the power supply apparatus in step S504 may further include detecting an OV state and a component fault state and turning off the output of the power converter when one of the following conditions is met: the first reflected voltage is less than or equal to the first normal regulation voltage, and the second reflected voltage and the third reflected voltage are identical or substantially identical to each other, within manufacturing and/or measurement tolerances, and greater than the second normal regulation voltage; or the first reflected voltage is greater than the first normal regulation voltage, the second reflected voltage is less than or equal to the second normal regulation voltage, and the third reflected voltage is greater than the second normal regulation voltage.

According to an example embodiment, controlling the power supply apparatus in step S504 may further include detecting an OV state, reporting an OV, and turning off the output of the power converter when the following condition is met: the first reflected voltage is greater than the first normal regulation voltage, and the second reflected voltage and the third reflected voltage are identical or substantially identical to each other, within manufacturing and/or measurement tolerances, and greater than the second normal regulation voltage.

According to an example embodiment, controlling the power supply apparatus in step S504 may further include detecting a UV state, reporting a UV, and turning off the output of the power converter when the following condition is met: the second reflected voltage and the third reflected voltage are identical or substantially identical to each other, within manufacturing and/or measurement tolerances, and less than the second normal regulation voltage.

The power supply apparatus 400 and the method for the power supply apparatus 400 according to example embodiments have been described above with reference to FIG. 4 and FIG. 5. The following will describe specific responses of the controller 404 in the power supply apparatus 400 under different cases. To ensure the reliability of the common bus voltage, provide correct protection under over-voltage/under-voltage conditions, and report component faults correctly, the power supply apparatus 400 may be applied to the following cases.

Case 1: A resistor problem associated with the feedback voltage VFB1 (for example, a resistor problem of the resistor network in the first feedback module) may cause the VFB1-reflected voltage to be lower than the real V_out (see FIG. 2).

As the VFB1-reflected voltage is still less than the VFB2-reflected voltage, the controller continues using the feedback voltage VFB1 as feedback for output regulation control and thus the output is driven higher than expected, causing both the VFB2-reflected voltage and the VFB3-reflected voltage to be above the normal regulation. An OV state will be detected based on the feedback voltage VFB3, and the controller may turn off the output to avoid over-voltage of the output common bus. Therefore, when the VFB1-reflected voltage is less than or equal to the first normal regulation voltage, and the VFB2-reflected voltage and the VFB3-reflected voltage are identical or substantially identical to each other, within manufacturing and/or measurement tolerances, and greater than the second normal regulation voltage, the controller may detect an OV state and a component fault state, and turn off the output of the power converter.

Case 2: A resistor problem associated with the feedback voltage VFB1 may cause the VFB1-reflected voltage to be higher than the real V_out.

As the VFB1-reflected voltage is higher than the VFB2-reflected voltage, the controller changes to use the feedback voltage VFB2 as feedback for output regulation control. Because the VFB2-reflected voltage is the normal regulation voltage, the power supply output may be maintained at the normal regulation. Although the VFB1-reflected voltage is higher than the normal regulation voltage and the state of the feedback voltage VFB1 is not matched with the state of VFB2, the controller cannot report a component fault because it cannot distinguish whether it is a resistor problem or the high VFB1-reflected voltage is caused by another power supply. In this case, the controller may report a component fault if the power supply output current I_out (see FIG. 2) is higher than a fault current threshold I_fault. This is because if the high V_out is caused by another power supply, the ORing device may be turned off, and no current flows from that power supply to the output common bus. However, if I_out is higher than I_fault, it may be supposed that I_out is not only dissipated by the internal circuit but also flows out to the output common bus. I_fault may be determined based on the maximum I_out drawn by the internal circuit connected only to V_int.

Therefore, as described above, the controller may report a component fault when the VFB1-reflected voltage is greater than the first normal regulation voltage, the VFB2-reflected voltage and the VFB3-reflected voltage are identical to each other and equal or substantially equal to the second normal regulation voltage, within manufacturing and/or measurement tolerances, and the output current I_out of the power converter is greater than the fault current threshold I_fault.

Case 3: A resistor problem associated with the feedback voltage VFB2 (for example, a resistor problem of the resistor network in the second feedback module) may cause the VFB2-reflected voltage to be lower than the real V_int (see FIG. 2).

As the VFB2-reflected voltage is lower than the real V_int, the VFB2-reflected voltage is lower than the VFB1-reflected voltage, and the controller changes to use the feedback voltage VFB2 as feedback for output regulation control. As a result, the controller will drive the output to be higher than expected. In this case, the controller may detect an OV state based on the feedback voltage VFB3 (that is, the VFB3-reflected voltage is higher than the normal regulation voltage), and therefore turn off the output to avoid over-voltage on the output common bus.

Therefore, when the VFB1-reflected voltage is greater than the first normal regulation voltage, the VFB2-reflected voltage is less than or equal to the second normal regulation voltage, and the VFB3-reflected voltage is greater than the second normal regulation voltage, the controller may detect an OV state and a component fault state, and turn off the output of the power converter.

Case 4: A resistor problem associated with the feedback voltage VFB2 may cause the VFB2-reflected voltage to be higher than the real V_int.

As the VFB1-reflected voltage is still less than the VFB2-reflected voltage, the controller keeps using the feedback voltage VFB1 as feedback for output regulation control, and thus the power supply output may be maintained in normal regulation. In this case, the controller may report a component fault because the VFB2-reflected voltage is unreasonably higher than the VFB1-reflected voltage. This may not happen unless the sensor resistor has a problem or the ORing device is turned on open circuit. Therefore, the controller may determine that it is a component fault.

Therefore, when the VFB1-reflected voltage is equal or substantially equal to the first normal regulation voltage, within manufacturing and/or measurement tolerances, the VFB2-reflected voltage is greater than the second normal regulation voltage, and the VFB3-reflected voltage is equal or substantially equal to the second normal regulation voltage, within manufacturing and/or measurement tolerances, the controller may report a component fault.

Case 5: A resistor problem associated with the feedback voltage VFB3 (for example, a resistor problem of the resistor network in the third feedback module) may cause the VFB3-reflected voltage to be lower than the real V_int.

In this case, the voltage feedback VFB2 will reflect that V_int is in normal regulation, but the feedback voltage VFB2 is not consistent with the VFB3-reflected voltage. This may be a faulty under-voltage state, and the controller may report component fault. In this case, the magnitude of the VFB1-reflected voltage may be ignored.

Therefore, when the VFB2-reflected voltage is equal or substantially equal to the second normal regulation voltage, within manufacturing and/or measurement tolerances, and the VFB3-reflected voltage is less than the second normal regulation voltage, the controller may report a component fault.

Case 6: A resistor problem associated with the feedback voltage VFB3 may cause the VFB3-reflected voltage to be higher than the real V_int.

In this case, the voltage feedback VFB2 will reflect that V_int is in normal regulation, but it is not consistent with the VFB3-reflected voltage. If the VFB1-reflected voltage is equal or substantially equal to the first normal regulation voltage, within manufacturing and/or measurement tolerances, it may be a faulty over-voltage, and the controller may report a component fault.

Therefore, when the VFB1-reflected voltage is equal or substantially equal to the first normal regulation voltage, within manufacturing and/or measurement tolerances, the VFB2-reflected voltage is equal or substantially equal to the second normal regulation voltage, within manufacturing and/or measurement tolerances, and the VFB3-reflected voltage is greater than the second normal regulation voltage, the controller may report a component fault.

Case 7: The power supply apparatus causes a real output under-voltage.

In this case, the output V_int of the power converter may be lower than the normal regulation voltage, and both the feedback voltage VFB2 and the feedback voltage VFB3 reflect that V_int is lower than the normal regulation voltage. The controller may turn off the output and report a UV fault. In this case, the feedback voltage VFB1 may be ignored because the output common bus may still maintain a normal regulation as the ORing device has been turned off.

Therefore, when the VFB2-reflected voltage and the VFB3-reflected voltage are identical or substantially identical to each other, within manufacturing and/or measurement tolerances, and less than the second normal regulation voltage, the controller may report UV and turn off the output of the power converter.

Case 8: The power supply apparatus causes a real output over-voltage.

In this case, the output V_int of the power converter may be higher than the normal regulation voltage, and both the feedback voltage VFB2 and the feedback voltage VFB3 reflect that V_int is higher than the normal regulation voltage. In this case, the feedback voltage VFB1 also reflects that V_out is higher than the normal regulation voltage. The controller may turn off the output and report an OV fault.

Therefore, when the VFB1-reflected voltage is greater than the first normal regulation voltage, and the VFB2-reflected voltage and the VFB3-reflected voltage are identical or substantially identical to each other, within manufacturing and/or measurement tolerances, and greater than the second normal regulation voltage, the controller may report OV and turn off the output of the power converter.

Case 9: Another power supply apparatus causes a real output over-voltage.

In this case, the VFB2-reflected voltage is lower than the VFB1-reflected voltage, then the controller changes to use the feedback voltage VFB2 as feedback for output regulation control, and the power supply apparatus continues normal operation, because the ORing device has been turned off and that power supply apparatus has been isolated from the output common bus. In this case, I_out is only dissipated by the internal circuit, and I_out may be not greater than I_fault.

Additionally, in the above cases where the controller reports a component fault (e.g., Case 2, Case 4, Case 5, and Case 6), the controller may turn off the output according to system requirements. Some systems may require the faulty power supply to remain on until it is replaced by maintenance personnel. However, some systems with sufficient redundant power supplies may require the faulty power supply to immediately turn off on its own.

For the nine cases described above, controller responses in different cases are summarized in Table 1 below.

TABLE 1

| | | VFB1- | VFB2- | VFB3- | |
|---|---|---|---|---|---|
| | | reflected | reflected | reflected | Controller |
| Case | Problem | voltage | voltage | voltage | response |
| 1 | Resistor | Lower than | Higher than | Higher than | Control output |
| | problem | or equal to | the normal | the normal | using VFB1, |
| | associated | the normal | regulation | regulation | detect OV based |
| | with VFB1 | regulation | voltage | voltage | on VFB3, and turn |
| | | voltage | | | off the output |
| 2 | Resistor | Higher than | At the | At the normal | Control output |
| | problem | the normal | normal | regulation | using VFB2, |
| | associated | regulation | regulation | voltage | report component |
| | with VFB1 | voltage | voltage | | fault if |
| | | | | | I_out > I_fault, and |
| | | | | | optionally turn off |
| | | | | | the output |
| 3 | Resistor | Higher than | Lower than | Higher than | Control output |
| | problem | the normal | or equal to | the normal | using VFB2, |
| | associated | regulation | the normal | regulation | detect OV based |
| | with VFB2 | voltage | regulation | voltage | on VFB3, and turn |
| | | | | | off the output |
| 4 | Resistor | At the | Higher than | At the normal | Control output |
| | problem | normal | the normal | regulation | using VFB1, |
| | associated | regulation | regulation | voltage | report component |
| | with VFB2 | voltage | voltage | | fault, and |
| | | | | | optionally turn off |
| | | | | | the output |
| 5 | Resistor | Ignored | At the | Lower than | Report component |
| | problem | | normal | the normal | fault and |
| | associated | | regulation | regulation | optionally turn off |
| | with VFB3 | | voltage | voltage | the output |
| 6 | Resistor | At the | At the | Higher than | Report component |
| | problem | normal | normal | the normal | fault and |
| | associated | regulation | regulation | regulation | optionally turn off |
| | with VFB3 | voltage | voltage | voltage | the output |
| 7 | Real | Ignored | Lower than | Lower than | Turn off the output |
| | output UV | | the normal | the normal | and report UV |
| | caused by | | regulation | regulation | |
| | the power | | voltage | voltage | |
| | supply PS | | | | |
| 8 | Real | Higher than | Higher than | Higher than | Turn off the output |
| | output OV | the normal | the normal | the normal | and report OV |
| | caused by | regulation | regulation | regulation | |
| | the power | voltage | voltage | voltage | |
| | supply PS | | | | |
| 9 | Real | Higher than | At the | At the normal | Control output |
| | output OV | the normal | normal | regulation | using VFB2, and |
| | caused by | regulation | regulation | voltage | continues normal |
| | another | voltage | voltage | | operation if |
| | power | | | | I_out <= I_fault |
| | supply PS | | | | |

Example embodiments of the present disclosure have been described in detail above with reference to the accompanying drawings, but the specific structures are not limited to the above example embodiments. References in the present disclosure to “one example embodiment,” “an example embodiment,” and the like indicate that the described example embodiment may include specific features, structures, or characteristics, but not each example embodiment necessarily includes the specific features, structures, or characteristics. Moreover, these phrases do not necessarily refer to the same example embodiment. Furthermore, when specific features, structures, or characteristics are described in combination with an example embodiment, it should be understood that implementing such a feature, structure, or characteristic in combination with other example embodiments (whether explicitly described or not) is within the scope of knowledge of those skilled in the art.

It should be understood that although terms such as “first”, “second” may be used herein to describe various elements, these elements should not be limited by these terms. These terms are only used to distinguish elements from each other. For example, without departing from the scope of the present disclosure, a first element may be referred to as a second element, and similarly, a second element may be referred to as a first element. As used herein, the term “and/or” includes any and all combinations of one or more of the associated listed items.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A power supply apparatus comprising:
an ORing device;
a power converter configured to provide an output voltage via the ORing device;
a controller;
a first feedback module connected between a downstream node of the ORing device and the controller and configured to provide a first voltage feedback to the controller;
a second feedback module connected between an upstream node of the ORing device and the controller and configured to provide a second voltage feedback to the controller; and
a third feedback module connected between the upstream node of the ORing device and the controller and configured to provide a third voltage feedback to the controller; wherein
the controller is configured or programmed to control the power supply apparatus based on the first voltage feedback, the second voltage feedback, and the third voltage feedback.

2. The power supply apparatus according to claim 1, wherein
the controller is further configured or programmed to detect a state of the power supply apparatus; and
the state of the power supply apparatus includes at least one of a component fault state, an over-voltage state, or an under-voltage state.

3. The power supply apparatus according to claim 1, wherein
each of the first feedback module, the second feedback module, and the third feedback module includes a feedback line and a resistor network;
the feedback line is connected between the controller and a node between resistors in the resistor network; and
each of the first voltage feedback, the second voltage feedback, and the third voltage feedback is transmitted to the controller through a corresponding feedback line.

4. The power supply apparatus according to claim 1, wherein
the controller is further configured or programmed to obtain a first reflected voltage, a second reflected voltage, and a third reflected voltage, respectively, based on the first voltage feedback, the second voltage feedback, and the third voltage feedback;
the first reflected voltage is a voltage at the downstream node of the ORing device reflected by the first voltage feedback, the second reflected voltage is a voltage at the upstream node of the ORing device reflected by the second voltage feedback, and the third reflected voltage is a voltage at the upstream node of the ORing device reflected by the third voltage feedback; and
when the power supply apparatus is in a normal operating state, the first reflected voltage is equal or substantially equal to a first normal regulation voltage, the second reflected voltage and the third reflected voltage are equal or substantially equal to a second normal regulation voltage, and the second normal regulation voltage is greater than or equal to the first normal regulation voltage.

5. The power supply apparatus according to claim 4, wherein the controller is further configured or programmed to:
regulate the output voltage of the power converter based on the first reflected voltage when the first reflected voltage is less than or equal to the second reflected voltage;
controller is further configured or programmed to regulate the output voltage of the power converter based on the second reflected voltage when the first reflected voltage is greater than the second reflected voltage; and
controller is further configured or programmed to detect an over-voltage or an under-voltage based on the third reflected voltage.

6. The power supply apparatus according to claim 5, wherein the controller is further configured or programmed to detect a component fault state and to report a component fault when any one of following conditions is met:
the first reflected voltage is greater than the first normal regulation voltage, the second reflected voltage and the third reflected voltage are identical or substantially identical to each other and equal or substantially equal to the second normal regulation voltage, and an output current of the power converter is greater than a fault current threshold;
the first reflected voltage is equal or substantially equal to the first normal regulation voltage, the second reflected voltage is greater than the second normal regulation voltage, and the third reflected voltage is equal or substantially equal to the second normal regulation voltage;
the second reflected voltage is equal or substantially equal to the second normal regulation voltage, and the third reflected voltage is less than the second normal regulation voltage; or
the first reflected voltage is equal or substantially equal to the first normal regulation voltage, the second reflected voltage is equal or substantially equal to the second normal regulation voltage, and the third reflected voltage is greater than the second normal regulation voltage.

7. The power supply apparatus according to claim 6, wherein
the under-voltage detected based on the third reflected voltage is determined as a faulty under-voltage when the second reflected voltage is equal or substantially equal to the second normal regulation voltage; and
the over-voltage detected based on the third reflected voltage is determined as a faulty over-voltage when the first reflected voltage is equal or substantially equal to the first normal regulation voltage as well as the second reflected voltage is equal or substantially equal to the second normal regulation voltage.

8. The power supply apparatus according to claim 6, wherein the controller is further configured or programmed to turn off an output of the power converter when reporting the component fault.

9. The power supply apparatus according to claim 5, wherein the controller is further configured or programmed to detect an over-voltage state and a component fault state and turn off an output of the power converter when any one of following conditions is met:
the first reflected voltage is less than or equal to the first normal regulation voltage, and the second reflected voltage and the third reflected voltage are identical or substantially identical to each other and greater than the second normal regulation voltage; or
the first reflected voltage is greater than the first normal regulation voltage, the second reflected voltage is less than or equal to the second normal regulation voltage, and the third reflected voltage is greater than the second normal regulation voltage.

10. The power supply apparatus according to claim 5, wherein the controller is further configured or programmed to detect an over-voltage state, report the over-voltage, and turn off an output of the power converter when a following condition is met:
the first reflected voltage is greater than the first normal regulation voltage, and the second reflected voltage and the third reflected voltage are identical or substantially identical to each other and greater than the second normal regulation voltage.

11. The power supply apparatus according to claim 5, wherein the controller is further configured or programmed to detect an under-voltage state, report the under-voltage, and turn off an output of the power converter when a following condition is met:
the second reflected voltage and the third reflected voltage are identical or substantially identical to each other and less than the second normal regulation voltage.

12. A method for a power supply apparatus including an ORing device, a power converter configured to provide an output voltage via the ORing device, and a controller, the method comprising:
providing a first voltage feedback, a second voltage feedback, and a third voltage feedback to the controller respectively by a first feedback module, a second feedback module, and a third feedback module of the power supply apparatus; and
controlling the power supply apparatus by the controller based on the first voltage feedback, the second voltage feedback, and the third voltage feedback; wherein
the first feedback module is connected between a downstream node of the ORing device and the controller, the second feedback module is connected between an upstream node of the ORing device and the controller, and the third feedback module is connected between the upstream node of the ORing device and the controller.

13. The method according to claim 12, further comprising:
obtaining a first reflected voltage, a second reflected voltage, and a third reflected voltage by the controller, respectively, based on the first voltage feedback, the second voltage feedback, and the third voltage feedback; wherein
the first reflected voltage is a voltage at the downstream node of the ORing device reflected by the first voltage feedback, the second reflected voltage is a voltage at the upstream node of the ORing device reflected by the second voltage feedback, and the third reflected voltage is a voltage at the upstream node of the ORing device reflected by the third voltage feedback; and
when the power supply apparatus is in a normal operating state, the first reflected voltage is equal or substantially equal to a first normal regulation voltage, and the second reflected voltage and the third reflected voltage are equal or substantially equal to a second normal regulation voltage, and the second normal regulation voltage is greater than or equal to the first normal regulation voltage.

14. The method according to claim 13, further comprising:
regulating the output voltage of the power converter by the controller based on the first reflected voltage when the first reflected voltage is less than or equal to the second reflected voltage;
regulating the output voltage of the power converter by the controller based on the second reflected voltage when the first reflected voltage is greater than the second reflected voltage; and
detecting an over-voltage or an under-voltage by the controller based on the third reflected voltage.

15. The method according to claim 14, wherein the controlling the power supply apparatus includes:
detecting a component fault state and reporting a component fault when any one of following conditions is met:
the first reflected voltage is greater than the first normal regulation voltage, the second reflected voltage and the third reflected voltage are identical or substantially identical to each other and equal or substantially equal to the second normal regulation voltage, and an output current of the power converter is greater than a fault current threshold;
the first reflected voltage is equal or substantially equal to the first normal regulation voltage, the second reflected voltage is greater than the second normal regulation voltage, and the third reflected voltage is equal or substantially equal to the second normal regulation voltage;
the second reflected voltage is equal or substantially equal to the second normal regulation voltage, and the third reflected voltage is less than the second normal regulation voltage; or
the first reflected voltage is equal or substantially equal to the first normal regulation voltage, the second reflected voltage is equal or substantially equal to the second normal regulation voltage, and the third reflected voltage is greater than the second normal regulation voltage.

16. The method according to claim 15, wherein
the under-voltage detected based on the third reflected voltage is determined as a faulty under-voltage when the second reflected voltage is equal or substantially equal to the second normal regulation voltage; and
the over-voltage detected based on the third reflected voltage is determined as a faulty over-voltage when the first reflected voltage is equal or substantially equal to the first normal regulation voltage and the second reflected voltage is equal or substantially equal to the second normal regulation voltage.

17. The method according to claim 14, wherein the controlling the power supply apparatus includes:
detecting an over-voltage state and a component fault state and turning off an output of the power converter when any one of following conditions is met:
the first reflected voltage is less than or equal to the first normal regulation voltage, and the second reflected voltage and the third reflected voltage are identical or substantially identical to each other and greater than the second normal regulation voltage; or
the first reflected voltage is greater than the first normal regulation voltage, the second reflected voltage is less than or equal to the second normal regulation voltage, and the third reflected voltage is greater than the second normal regulation voltage.

18. The method according to claim 14, wherein the controlling the power supply apparatus includes:
detecting an over-voltage state, reporting the over-voltage, and turning off an output of the power converter when a following condition is met:
the first reflected voltage is greater than the first normal regulation voltage, and the second reflected voltage and the third reflected voltage are identical or substantially identical to each other and greater than the second normal regulation voltage.

19. The method according to claim 14, wherein the controlling the power supply apparatus includes:
detecting an under-voltage state, reporting the under-voltage, and turning off an output of the power converter when a following condition is met:
the second reflected voltage and the third reflected voltage are identical or substantially identical to each other and less than the second normal regulation voltage.

20. A redundant power supply system comprising:
a plurality of power supply apparatuses; and
an output common bus; wherein
each of the plurality of power supply apparatuses is the power supply apparatus according to claim 1, and outputs of the plurality of power supply apparatuses are connected to the output common bus.
